(19) United States
(12) Patent Application Publication
(10) Pub. No.: US 2026/0290016 A1
(43) Pub. Date: Sep. 24, 2026

(54) System and Method for Generating and Analyzing Metadata from Live Video Streams Using an On-Camera Agentic Application and Serverless Cloud Backend

(71) Applicant: Anava, Inc., Weatherby Lake, MO (US)

(72) Inventors: Ryan Wager, Weatherby Lake, MO (US); John B. Fowler, Salt Lake City, UT (US); Matthew J. Ebben, Chandler, AZ (US); Rhett R. Place, Overland Park, KS (US); Daniel S. Davidson, Gladstone, MO (US); Ryan J. Echols, Weatherby Lake, MO (US)

(21) Appl. No.: 19/572,751

(22) Filed: Mar. 19, 2026

Related U.S. Application Data
(60) Provisional application No. 63/775,905, filed on Mar. 21, 2025.
(60) Provisional application No. 63/775,900, filed on Mar. 21, 2025.
(60) Provisional application No. 63/775,996, filed on Mar. 21, 2025.

(51) Int. Cl. G06V 20/40; H04N 19/85

(52) U.S. Cl. CPC G06V 20/46; G06V 20/44; H04N 19/85

(57) ABSTRACT

A system and method for generating and analyzing metadata from a live video stream. A smart camera captures the live video stream and an on-camera agentic application extracts keyframes, compresses the extracted keyframes, and transmits the compressed keyframes to an external artificial intelligence service via a network. The external artificial intelligence service returns structured responses representing characteristics of captured scenes. An infinite metadata generation module continuously generates metadata from the structured responses representing quantitative and qualitative attributes of the captured scenes. A serverless cloud backend receives, stores, and performs real-time analytics on the metadata. A dual-stage processing pipeline filters keyframes through a low-cost first stage before engaging advanced analysis upon satisfaction of a predefined condition. A user interface module routes real-time queries to the on-camera agentic application and analytical queries to the serverless cloud backend.

### CROSS REFERENCE TO RELATED APPLICATIONS

This application claims the benefit and priority of U.S. Provisional Application Ser. No. 63/775,905, filed on Mar. 21, 2025, of U.S. Provisional Application Ser. No. 63/775,900, filed on Mar. 21, 2025, and of U.S. Provisional Application Ser. No. 63/775,996, filed on Mar. 21, 2025, each of which is hereby incorporated by reference herein in it its entirety, including all references and appendices cited therein, for all purposes, as if full set forth herein.

This application is related to U.S. Patent Application Serial Number X, filed on Mar. 19, 2026, entitled “EDGE EVENT DRIVEN CAMERA ANALYSIS AND RESPONSE SYSTEMS AND METHODS”, which is herein incorporated by reference herein in its entirety, including all references and appendices cited therein for all purposes, as if fully set forth herein.

### FIELD

The present disclosure relates to systems and methods for real-time video stream analysis and metadata generation, and more particularly, to an on-camera agentic application that extracts keyframes from a live video stream, transmits the extracted keyframes to an external artificial intelligence service for analysis, continuously generates an unbounded stream of metadata from structured AI responses, and transmits the metadata to a serverless cloud backend for storage and real-time analytics.

### BACKGROUND

Conventional camera analytics systems are limited to predefined event types such as motion detection and fixed object classification. These systems require backend schema modifications to add new data attributes, and each new analytics capability requires a dedicated processing pipeline. Security cameras in conventional deployments generate fixed metadata tied to specific use cases, and extending the range of captured metadata requires reconfiguration of both the camera-side processing and the backend data infrastructure.

Historical analysis in conventional camera analytics systems typically occurs in hindsight after data collection, without real-time operational awareness. A business analyst reviewing aggregated data at the end of a reporting period may identify trends or anomalies, but by that time the conditions giving rise to those trends have already passed. The delay between data collection and actionable insight limits the utility of conventional camera analytics for time-sensitive operational decisions such as inventory management, security response, and customer engagement.

Conventional camera analytics systems also lack the ability to correlate camera-derived metadata with external business data sources in real time. Even where a conventional system captures relevant scene data, the fixed schema of the backend database constrains the types of queries that can be performed and the types of correlations that can be drawn. Adding a new query attribute to a conventional system requires altering the database schema, updating the processing pipeline, and redeploying the analytics interface, introducing delays and engineering overhead that prevent rapid adaptation to changing business needs.

Furthermore, conventional camera analytics systems treat each camera as an isolated data source tied to a single location and a single set of predefined analytics. Aggregating data across multiple camera locations and timeframes requires manual data export and consolidation, and the resulting analysis is limited to the predefined attributes captured by each camera. There is no mechanism in conventional systems for a user to define an arbitrary question, direct that question to a camera, and receive an immediate answer derived from artificial intelligence analysis of the live scene.

### SUMMARY

In accordance with one aspect, a system comprises a smart camera comprising a processing unit, a memory coupled to the processing unit, and an image sensor configured to capture a live video stream. The system further comprises an on-camera agentic application stored in the memory and configured to be executed by the processing unit. The on-camera agentic application comprises a continuous keyframe extraction module configured to extract keyframes from the live video stream, an image compression and preprocessing module configured to compress the extracted keyframes to reduce data size, an external AI processing module configured to transmit the compressed keyframes to an external artificial intelligence service via a network and to receive structured AI responses from the external artificial intelligence service, the structured AI responses representing characteristics of scenes captured in the live video stream, and an infinite metadata generation module configured to continuously generate an unbounded stream of metadata from the structured AI responses, the metadata representing quantitative and qualitative attributes of the captured scenes. The system further comprises a serverless cloud backend communicatively coupled to the on-camera agentic application via the network and configured to receive the metadata and the structured AI responses from the on-camera agentic application, store the metadata and the structured AI responses, and perform real-time analytics on the stored metadata.

In accordance with another aspect, a method comprises capturing, via an image sensor of a smart camera comprising a processing unit and a memory coupled to the processing unit, a live video stream. The method further comprises extracting, via a continuous keyframe extraction module of an on-camera agentic application stored in the memory and executing on the processing unit, keyframes from the live video stream. The method further comprises compressing, via an image compression and preprocessing module of the on-camera agentic application, the extracted keyframes to reduce data size. The method further comprises transmitting, via an external AI processing module of the on-camera agentic application, the compressed keyframes to an external artificial intelligence service via a network. The method further comprises receiving, from the external artificial intelligence service via the network, structured AI responses representing characteristics of scenes captured in the live video stream. The method further comprises continuously generating, via an infinite metadata generation module of the on-camera agentic application, an unbounded stream of metadata from the structured AI responses, the metadata representing quantitative and qualitative attributes of the captured scenes. The method further comprises transmitting, via the network, the metadata and the structured AI responses to a serverless cloud backend. The method further comprises storing, by the serverless cloud backend, the metadata and the structured AI responses. The method further comprises performing, by the serverless cloud backend, real-time analytics on the stored metadata.

In accordance with yet another aspect, a system comprises a smart camera comprising a processing unit, a memory coupled to the processing unit, and an image sensor configured to capture a live video stream. The system further comprises an on-camera agentic application stored in the memory and configured to be executed by the processing unit. The on-camera agentic application comprises a continuous keyframe extraction module configured to extract keyframes from the live video stream, an image compression and preprocessing module configured to compress the extracted keyframes to reduce data size, an external AI processing module configured to perform a dual-stage AI processing pipeline on the compressed keyframes, the dual-stage AI processing pipeline comprising a first stage configured to perform a low-cost filtering pass on the compressed keyframes and a second stage configured to transmit the compressed keyframes to an external artificial intelligence service via a network and to receive structured AI responses from the external artificial intelligence service upon satisfaction of a predefined condition evaluated by the first stage, the structured AI responses representing characteristics of scenes captured in the live video stream, an infinite metadata generation module configured to continuously generate an unbounded stream of metadata from the structured AI responses, the metadata representing quantitative and qualitative attributes of the captured scenes, and a standardized event conversion module configured to convert the structured AI responses and the metadata into event messages compliant with at least one standardized communication protocol. The system further comprises a serverless cloud backend communicatively coupled to the on-camera agentic application via the network and configured to receive the metadata and the structured AI responses from the on-camera agentic application, store the metadata and the structured AI responses in a schema-free database, and perform real-time analytics on the stored metadata, the schema-free database configured to accommodate dynamically extensible data attributes without requiring database schema modifications. The system further comprises a user interface module communicatively coupled to the on-camera agentic application and to the serverless cloud backend and configured to route real-time queries to the on-camera agentic application for immediate AI evaluation of the live video stream and to route analytical queries to the serverless cloud backend for historical data analysis of the stored metadata.

### BRIEF DESCRIPTION OF THE DRAWINGS

FIG. 1 is a block diagram of a system for generating and analyzing metadata from a live video stream according to an embodiment.

FIG. 2 is a flowchart of a dual-stage AI processing pipeline according to an embodiment.

FIG. 3 is a flowchart of metadata generation and query flow according to an embodiment.

FIG. 4 is a schematic diagram of an example computing system that can be used in accordance with the present disclosure.

### DETAILED DESCRIPTION OF EXAMPLE EMBODIMENTS

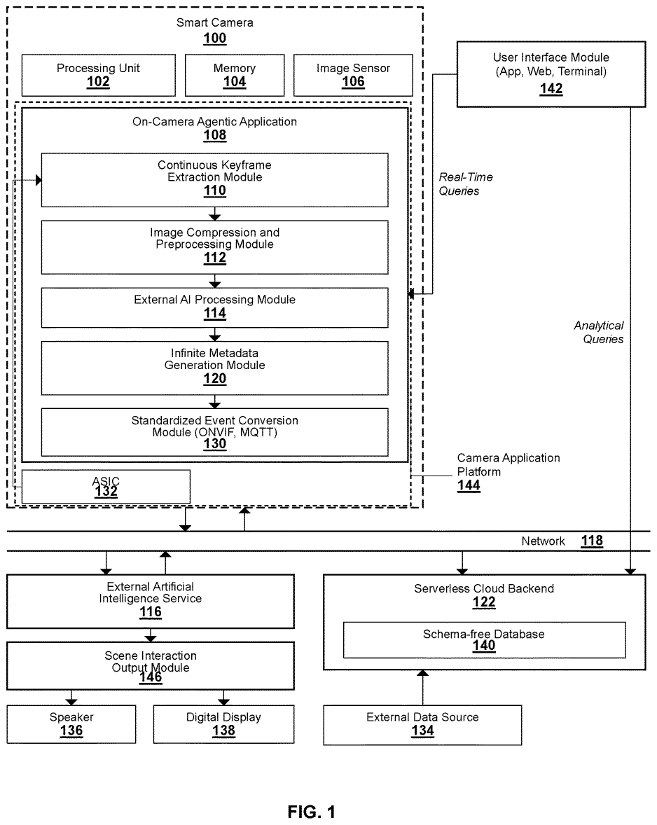

Referring to FIG. 1, a system for generating and analyzing metadata from a live video stream is shown in accordance with an embodiment. The system comprises a smart camera 100, an on-camera agentic application 108, a user interface module 142, a network 118, an external artificial intelligence (AI) service 116, a serverless cloud backend 122, and a scene interaction output module 146. The smart camera 100 captures a live video stream and transmits the live video stream to the on-camera agentic application 108 for processing. The on-camera agentic application 108 extracts keyframes from the live video stream, compresses the extracted keyframes, transmits the compressed keyframes to the external artificial intelligence service 116 via the network 118, receives structured AI responses from the external artificial intelligence service 116, and continuously generates an unbounded stream of metadata from the structured AI responses. The serverless cloud backend 122 receives the metadata and the structured AI responses from the on-camera agentic application 108 via the network 118, stores the metadata and the structured AI responses, and performs real-time analytics on the stored metadata.

The smart camera 100 comprises a processing unit 102, a memory 104 coupled to the processing unit 102, and an image sensor 106 configured to capture a live video stream. The processing unit 102 executes the on-camera agentic application 108, which is stored in the memory 104. The image sensor 106 captures the live video stream and provides the live video stream to the on-camera agentic application 108 for downstream processing. In some embodiments, the smart camera 100 further comprises an application-specific integrated circuit 132 configured to detect predefined triggering events from the live video stream. The application-specific integrated circuit 132 performs initial hardware-level event detection, including detection of at least one of a human, a license plate, or an object of interest, and provides triggering signals to the on-camera agentic application 108 based on the predefined triggering events.

The on-camera agentic application 108 is stored in the memory 104 and configured to be executed by the processing unit 102. The on-camera agentic application 108 is configured to operate as a compiled binary within a camera application platform 144 of the smart camera 100. The camera application platform 144 provides an execution environment that enables the on-camera agentic application 108 to perform kernel-level event monitoring and direct sensor interactions with the image sensor 106. Operating as a compiled binary within the camera application platform 144 allows the on-camera agentic application 108 to access low-level hardware interfaces of the smart camera 100, including direct communication with the image sensor 106 and the application-specific integrated circuit 132, without the overhead associated with interpreted or virtualized execution environments.

The on-camera agentic application 108 comprises a continuous keyframe extraction module 110 configured to extract keyframes from the live video stream. The continuous keyframe extraction module 110 receives the live video stream from the image sensor 106 and selects keyframes for downstream processing. In some embodiments, the continuous keyframe extraction module 110 is configured to extract the keyframes in response to the predefined triggering events detected by the application-specific integrated circuit 132. The predefined triggering events comprise detection of at least one of a human, a license plate, or an object of interest. When the application-specific integrated circuit 132 detects a predefined triggering event in the live video stream, the application-specific integrated circuit 132 signals the continuous keyframe extraction module 110, and the continuous keyframe extraction module 110 extracts one or more keyframes corresponding to the detected event. In other embodiments, the continuous keyframe extraction module 110 extracts keyframes at predetermined intervals irrespective of triggering events, thereby maintaining a continuous sampling of the live video stream.

The on-camera agentic application 108 further comprises an image compression and preprocessing module 112 configured to compress the extracted keyframes to reduce data size. The image compression and preprocessing module 112 receives the extracted keyframes from the continuous keyframe extraction module 110 and applies compression techniques to the extracted keyframes. The image compression and preprocessing module 112 employs cropping and tiling techniques to reduce the data size of the extracted keyframes while maintaining scene-critical visual details. In some embodiments, the image compression and preprocessing module 112 is further configured to perform a composite-image transformation by arranging a plurality of sequential frames from the live video stream into a single composite image to provide the external artificial intelligence service 116 with contextual temporal awareness. The composite-image transformation arranges multiple sequential frames into a spatially organized layout within a single image, enabling the external artificial intelligence service 116 to perceive temporal relationships across the plurality of sequential frames in a single inference pass.

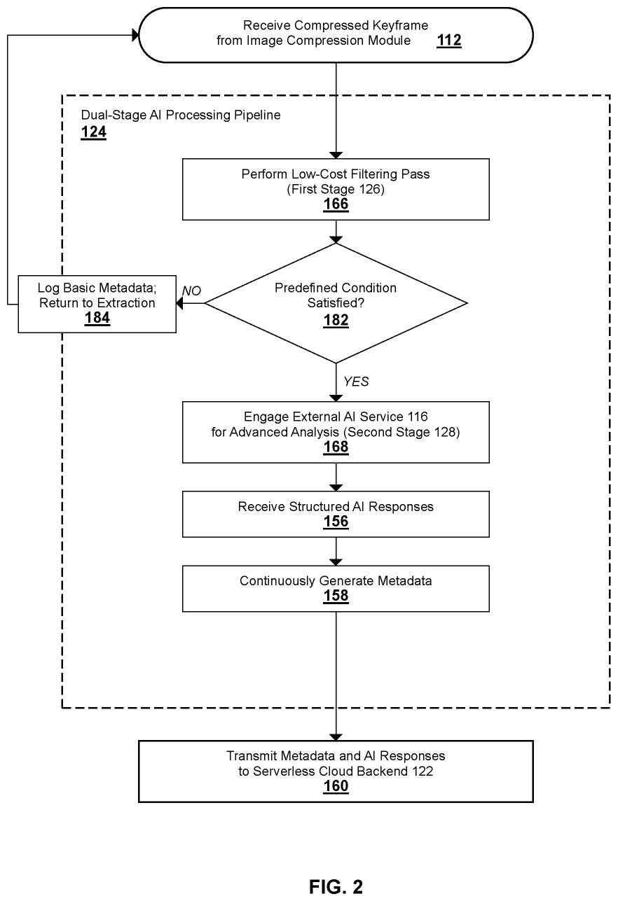

The on-camera agentic application 108 further comprises an external AI processing module 114 configured to transmit the compressed keyframes to an external artificial intelligence service 116 via a network 118 and to receive structured AI responses from the external artificial intelligence service 116. The external AI processing module 114 receives the compressed keyframes from the image compression and preprocessing module 112 and constructs requests containing the compressed keyframes and structured prompts for transmission to the external artificial intelligence service 116 over the network 118. The structured AI responses received from the external artificial intelligence service 116 represent characteristics of scenes captured in the live video stream. The structured AI responses are formatted in a programmatically parseable format, such as JavaScript Object Notation (JSON), and encapsulate scene characteristics including object counts, spatial relationships, environmental conditions, and inferred behavioral insights. In some embodiments, the external AI processing module 114 is configured to perform a dual-stage AI processing pipeline on the compressed keyframes, the dual-stage AI processing pipeline comprising a first stage configured to perform a low-cost filtering pass on the compressed keyframes and a second stage configured to perform an advanced analysis via the external artificial intelligence service 116. The second stage is engaged upon satisfaction of a predefined condition evaluated by the first stage, as described in further detail with reference to FIG. 2.

The on-camera agentic application 108 further comprises an infinite metadata generation module 120 configured to continuously generate an unbounded stream of metadata from the structured AI responses. The infinite metadata generation module 120 receives the structured AI responses from the external AI processing module 114 and derives the metadata from the structured AI responses. The metadata represents quantitative and qualitative attributes of the captured scenes. The quantitative attributes include object counts, spatial measurements, dwell times, and frequency metrics derived from the structured AI responses. The qualitative attributes include behavioral classifications, scene condition assessments, and inferred contextual information derived from the structured AI responses. The unbounded nature of the metadata generated by the infinite metadata generation module 120 permits users to define arbitrary query attributes at any time, and the infinite metadata generation module 120 incorporates each newly defined attribute into the metadata stream without requiring modification to the on-camera agentic application 108 or the serverless cloud backend 122.

The on-camera agentic application 108 further comprises a standardized event conversion module 130 configured to convert the structured AI responses and the metadata into event messages compliant with at least one standardized communication protocol. The standardized event conversion module 130 receives the structured AI responses and the metadata from the infinite metadata generation module 120 and converts the structured AI responses and the metadata into event messages conforming to the Open Network Video Interface Forum (ONVIF) protocol and the Message Queuing Telemetry Transport (MQTT) protocol. The event messages generated by the standardized event conversion module 130 enable seamless integration of the smart camera 100 with third-party security hardware, surveillance systems, and automation platforms that communicate using the ONVIF protocol, the MQTT protocol, or both.

The network 118 communicatively couples the smart camera 100 to the external artificial intelligence service 116 and to the serverless cloud backend 122. The on-camera agentic application 108 transmits the compressed keyframes to the external artificial intelligence service 116 via the network 118 and receives the structured AI responses from the external artificial intelligence service 116 via the network 118. The on-camera agentic application 108 further transmits the metadata and the structured AI responses to the serverless cloud backend 122 via the network 118. The network 118 supports bidirectional communication between the smart camera 100 and both the external artificial intelligence service 116 and the serverless cloud backend 122.

The external artificial intelligence service 116 is communicatively coupled to the on-camera agentic application 108 via the network 118. The external artificial intelligence service 116 receives the compressed keyframes from the external AI processing module 114 and analyzes the compressed keyframes using one or more artificial intelligence models. The external artificial intelligence service 116 generates the structured AI responses based on the analysis of the compressed keyframes and transmits the structured AI responses to the external AI processing module 114 via the network 118. In some embodiments, the external AI processing module 114 is configured to generate the structured AI responses by analyzing collective behavioral patterns of a plurality of subjects within the captured scenes, the collective behavioral patterns comprising trajectories and reactions of the plurality of subjects relative to one another. The external AI processing module 114 directs the external artificial intelligence service 116 to analyze the collective behavioral patterns by transmitting the compressed keyframes together with structured prompts specifying collective behavioral analysis criteria. For example, the external AI processing module 114 may cause the external artificial intelligence service 116 to infer that a particular individual presents a threat based not on the behavior of that individual alone, but on the trajectories and reactions of other individuals in the scene who are moving away from the particular individual, thereby leveraging collective behavioral analysis to identify conditions that would not be apparent from analysis of any single subject in isolation.

The serverless cloud backend 122 is communicatively coupled to the on-camera agentic application 108 via the network 118 and configured to receive the metadata and the structured AI responses from the on-camera agentic application 108, store the metadata and the structured AI responses, and perform real-time analytics on the stored metadata. The serverless cloud backend 122 comprises a schema-free database 140 configured to accommodate dynamically extensible data attributes without requiring database schema modifications. The schema-free database 140 stores the metadata and the structured AI responses received from the on-camera agentic application 108. Because the schema-free database 140 does not enforce a fixed schema, users may add new query attributes to the metadata at any time, and the schema-free database 140 immediately incorporates the new attributes without requiring alterations to the schema of the schema-free database 140. Conversely, when a user removes a previously defined attribute, subsequent metadata records stored in the schema-free database 140 simply omit that attribute, and historical records containing the removed attribute remain available for retrospective queries spanning both timeframes. In some embodiments, the serverless cloud backend 122 is further configured to correlate the stored metadata with external data received from an external data source 134 to perform cross-domain anomaly detection and to generate threshold-triggered proactive notifications based on the cross-domain anomaly detection. The external data source 134 may comprise a point-of-sale system, a revenue tracking system, or another business intelligence data source, and the serverless cloud backend 122 correlates the stored metadata with the external data to identify relationships between scene-derived observations and business metrics. In some embodiments, the serverless cloud backend 122 is further configured to aggregate the stored metadata received from a plurality of smart cameras 100 deployed across a plurality of geographic locations and to perform the real-time analytics across the plurality of geographic locations and across a plurality of timeframes.

The user interface module 142 is communicatively coupled to the on-camera agentic application 108 and to the serverless cloud backend 122 and configured to route real-time queries to the on-camera agentic application 108 for immediate artificial intelligence evaluation of the live video stream and to route analytical queries to the serverless cloud backend 122 for historical data analysis of the stored metadata. The user interface module 142 is accessible via a mobile application, a web-based dashboard, or a dedicated hardware terminal. When a user submits a real-time query through the user interface module 142, the user interface module 142 transmits the real-time query to the on-camera agentic application 108, and the on-camera agentic application 108 processes the real-time query by transmitting the compressed keyframes together with a user-defined structured prompt specifying the real-time query to the external artificial intelligence service 116 for analysis of the compressed keyframes according to the user-defined structured prompt. When a user submits an analytical query through the user interface module 142, the user interface module 142 transmits the analytical query to the serverless cloud backend 122, and the serverless cloud backend 122 performs historical data analysis on the stored metadata in accordance with the analytical query. In some embodiments, the user interface module 142 is communicatively coupled to the on-camera agentic application 108 and to the serverless cloud backend 122 via a secure communication protocol comprising at least one of Hypertext Transfer Protocol Secure (HTTPS) or WebSocket.

The scene interaction output module 146 is communicatively coupled to the on-camera agentic application 108 and configured to generate, based on the structured AI responses, at least one of a verbal output through a speaker 136 or a visual output through a digital display 138 directed to an individual within a scene captured by the live video stream. The scene interaction output module 146 receives the structured AI responses from the external artificial intelligence service 116 and determines appropriate real-time outputs based on the content of the structured AI responses. The speaker 136 is communicatively coupled to the scene interaction output module 146 and configured to produce verbal outputs including contextual announcements, personalized greetings, security deterrent messages, and targeted promotional messages directed to individuals within the scene. The digital display 138 is communicatively coupled to the scene interaction output module 146 and configured to present visual outputs including text-based notifications, graphical alerts, and informational content directed to individuals within the scene. In a retail environment, for example, the scene interaction output module 146 may generate a verbal output through the speaker 136 greeting a customer and informing the customer about a promotional offer based on the structured AI responses indicating characteristics of the customer. In a security environment, the scene interaction output module 146 may generate a verbal output through the speaker 136 issuing a deterrent message to an individual identified as presenting a potential threat based on collective behavioral analysis performed by the external artificial intelligence service 116.

Referring to FIG. 2, a flowchart illustrating operation of the dual-stage AI processing pipeline 124 is shown in accordance with an embodiment. The dual-stage AI processing pipeline 124 comprises a first stage 126 configured to perform a low-cost filtering pass on the compressed keyframes and a second stage 128 configured to perform an advanced analysis via the external artificial intelligence service 116. The second stage 128 is engaged upon satisfaction of a predefined condition evaluated by the first stage 126. The dual-stage AI processing pipeline 124 receives compressed keyframes from the image compression and preprocessing module 112, processes the compressed keyframes through the first stage 126 and, conditionally, through the second stage 128, and outputs metadata and structured AI responses for transmission to the serverless cloud backend 122.

The dual-stage AI processing pipeline 124 begins when the external AI processing module 114 receives a compressed keyframe from the image compression and preprocessing module 112. The image compression and preprocessing module 112 provides the compressed keyframe to the dual-stage AI processing pipeline 124 after applying compression techniques to reduce data size while preserving scene-critical visual details, as described with reference to FIG. 1.

In step 166, the first stage 126 of the dual-stage AI processing pipeline 124 performs a low-cost filtering pass on the compressed keyframes. The low-cost filtering pass evaluates the compressed keyframes using a computationally efficient model to determine whether further analysis is warranted. The first stage 126 applies the low-cost filtering pass to each compressed keyframe received from the image compression and preprocessing module 112, thereby screening the compressed keyframes before committing computational resources to the more intensive second stage 128. The low-cost filtering pass performed by the first stage 126 minimizes unnecessary data transmission and computational overhead by preventing compressed keyframes that do not satisfy the predefined condition from advancing to the second stage 128.

In step 182, the dual-stage AI processing pipeline 124 evaluates whether a predefined condition is satisfied based on the results of the low-cost filtering pass performed in step 166. The predefined condition serves as a gating criterion that determines whether the compressed keyframe warrants the advanced analysis performed by the second stage 128. The predefined condition may comprise a confidence score threshold, an object detection count, a scene change metric, or another evaluative criterion derived from the low-cost filtering pass of the first stage 126. The evaluation performed in step 182 produces one of two outcomes: the predefined condition is satisfied, directing the compressed keyframe to the second stage 128 for advanced analysis, or the predefined condition is not satisfied, directing the compressed keyframe along an alternative path.

When the predefined condition evaluated in step 182 is not satisfied, the method proceeds to step 184. In step 184, the dual-stage AI processing pipeline 124 logs basic metadata derived from the low-cost filtering pass of the first stage 126 and returns to the entry point of the dual-stage AI processing pipeline 124 to receive a subsequent compressed keyframe from the image compression and preprocessing module 112. The basic metadata logged in step 184 preserves a record of the scene observation made by the first stage 126 even when the compressed keyframe does not warrant advanced analysis. By logging the basic metadata and returning to receive the next compressed keyframe, step 184 ensures that the dual-stage AI processing pipeline 124 maintains continuous operation without expending computational resources on the second stage 128 for compressed keyframes that do not satisfy the predefined condition.

When the predefined condition evaluated in step 182 is satisfied, the method proceeds to step 168. In step 168, the second stage 128 of the dual-stage AI processing pipeline 124 engages the external artificial intelligence service 116 to perform an advanced analysis on the compressed keyframes. The second stage 128 transmits the compressed keyframes to the external artificial intelligence service 116 via the network 118, and the external artificial intelligence service 116 applies one or more computationally intensive artificial intelligence models to the compressed keyframes. The advanced analysis performed by the external artificial intelligence service 116 produces detailed scene interpretations that exceed the analytical depth of the low-cost filtering pass performed by the first stage 126. The external artificial intelligence service 116 evaluates the compressed keyframes according to user-defined structured prompts specifying queries for real-time evaluation of the live video stream, generating the structured AI responses representing characteristics of scenes captured in the live video stream.

Following the advanced analysis performed in step 168, the method proceeds to step 156. In step 156, the external AI processing module 114 receives the structured AI responses from the external artificial intelligence service 116 via the network 118. The structured AI responses received in step 156 are formatted in a structured, programmatically parseable format representing characteristics of scenes captured in the live video stream. The structured AI responses include scene characteristics such as object counts, spatial relationships, environmental conditions, behavioral classifications, and inferred contextual information derived from the advanced analysis of the compressed keyframes.

The method proceeds from step 156 to step 158. In step 158, the infinite metadata generation module 120 continuously generates an unbounded stream of metadata from the structured AI responses received in step 156. The metadata generated in step 158 represents quantitative and qualitative attributes of the captured scenes. The quantitative attributes include object counts, spatial measurements, dwell times, and frequency metrics. The qualitative attributes include behavioral classifications, scene condition assessments, and inferred contextual information. Because the infinite metadata generation module 120 generates the metadata from the structured AI responses on a continuous basis, each compressed keyframe that satisfies the predefined condition and advances through the second stage 128 contributes additional metadata to the unbounded stream, progressively expanding the dataset available for analytics.

The method proceeds from step 158 to step 160, which is outside the boundary of the dual-stage AI processing pipeline 124. In step 160, the on-camera agentic application 108 transmits the metadata and the structured AI responses to the serverless cloud backend 122 via the network 118. The serverless cloud backend 122 receives the metadata and the structured AI responses transmitted in step 160, stores the metadata and the structured AI responses, and performs real-time analytics on the stored metadata. The transmission performed in step 160 delivers both the metadata generated by the infinite metadata generation module 120 in step 158 and the structured AI responses received from the external artificial intelligence service 116 in step 156 to the serverless cloud backend 122 for storage and analytical processing.

The dual-stage AI processing pipeline 124 depicted in FIG. 2 may be scaled to a multi-pass operation having more than two stages. In some embodiments, one or more additional intermediate stages are interposed between the first stage 126 and the second stage 128, each additional intermediate stage configured to apply progressively more detailed analysis before engaging the external artificial intelligence service 116 for the advanced analysis in the second stage 128. The multi-pass configuration further reduces computational overhead by introducing additional gating criteria at each intermediate stage, ensuring that only compressed keyframes warranting the most detailed analysis reach the external artificial intelligence service 116.

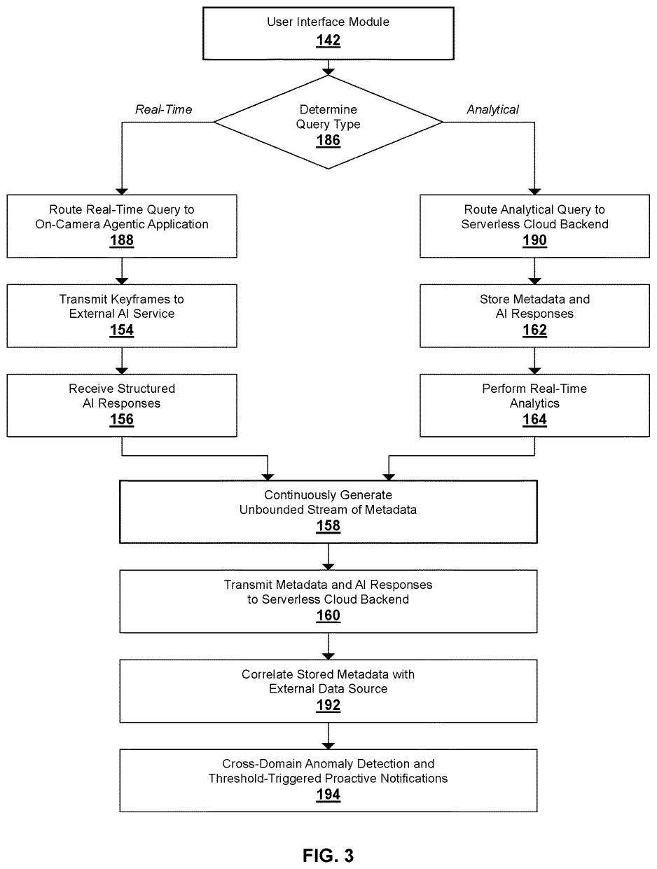

Referring to FIG. 3, a flowchart illustrating metadata generation and query flow is shown in accordance with an embodiment. The flowchart depicts two parallel query paths originating from the user interface module 142: a real-time query path in which the user interface module 142 routes real-time queries to the on-camera agentic application 108 for immediate AI evaluation of the live video stream, and an analytical query path in which the user interface module 142 routes analytical queries to the serverless cloud backend 122 for historical data analysis of the stored metadata. Both paths converge into a continuous metadata generation and analytics chain that includes transmission of the metadata and the structured AI responses to the serverless cloud backend 122, correlation of the stored metadata with external data received from an external data source 134, and cross-domain anomaly detection with threshold-triggered proactive notifications.

A user submits a query through the user interface module 142. In step 186, the user interface module 142 determines the query type by classifying the submitted query as either a real-time query or an analytical query. The classification performed in step 186 governs which downstream processing path the query follows. A real-time query requests immediate AI evaluation of the live video stream, and the user interface module 142 routes the real-time query along the left path of the flowchart. An analytical query requests historical data analysis of the stored metadata, and the user interface module 142 routes the analytical query along the right path of the flowchart.

When the query type determined in step 186 is a real-time query, the method proceeds to step 188. In step 188, the user interface module 142 routes the real-time query to the on-camera agentic application 108 for immediate AI evaluation of the live video stream. The on-camera agentic application 108 receives the real-time query from the user interface module 142 and processes the real-time query by preparing the compressed keyframes together with a user-defined structured prompt specifying the real-time query for transmission to the external artificial intelligence service 116.

The method proceeds from step 188 to step 154. In step 154, the external AI processing module 114 transmits the compressed keyframes to the external artificial intelligence service 116 via the network 118. The compressed keyframes transmitted in step 154 are accompanied by the user-defined structured prompt received in step 188, enabling the external artificial intelligence service 116 to analyze the compressed keyframes according to the criteria specified in the real-time query. The external artificial intelligence service 116 applies one or more artificial intelligence models to the compressed keyframes and generates the structured AI responses representing characteristics of scenes captured in the live video stream.

The method proceeds from step 154 to step 156. In step 156, the external AI processing module 114 receives the structured AI responses from the external artificial intelligence service 116 via the network 118. The structured AI responses received in step 156 are formatted in a structured, programmatically parseable format and include scene characteristics responsive to the real-time query submitted in step 188. The real-time query path concludes at step 156 with the structured AI responses available for downstream metadata generation.

When the query type determined in step 186 is an analytical query, the method proceeds to step 190. In step 190, the user interface module 142 routes the analytical query to the serverless cloud backend 122 for historical data analysis of the stored metadata. The serverless cloud backend 122 receives the analytical query from the user interface module 142 and initiates historical data analysis on the stored metadata in accordance with the criteria specified in the analytical query.

The method proceeds from step 190 to step 162. In step 162, the serverless cloud backend 122 stores the metadata and the structured AI responses received from the on-camera agentic application 108. The metadata and the structured AI responses stored in step 162 are accumulated over time in the schema-free database 140 of the serverless cloud backend 122, forming a progressively expanding dataset of scene-derived observations. Because the schema-free database 140 accommodates dynamically extensible data attributes without requiring database schema modifications, each new query attribute added by a user is immediately incorporated into the stored metadata without altering the schema of the schema-free database 140.

The method proceeds from step 162 to step 164. In step 164, the serverless cloud backend 122 performs real-time analytics on the stored metadata. The real-time analytics performed in step 164 include aggregation of the stored metadata across a plurality of smart cameras 100 deployed across a plurality of geographic locations and across a plurality of timeframes. Users define custom queries through the user interface module 142 to analyze historical data, identify trends, and detect anomalies within the stored metadata using business intelligence tools integrated with the serverless cloud backend 122.

Both the real-time query path and the analytical query path converge at step 158. In step 158, the infinite metadata generation module 120 continuously generates an unbounded stream of metadata from the structured AI responses. The metadata generated in step 158 represents quantitative and qualitative attributes of the captured scenes and is produced on a continuous basis irrespective of whether the initiating query was a real-time query or an analytical query. The continuous generation performed in step 158 ensures that the dataset available for analytics expands with each processed keyframe.

The method proceeds from step 158 to step 160. In step 160, the on-camera agentic application 108 transmits the metadata and the structured AI responses to the serverless cloud backend 122 via the network 118. The serverless cloud backend 122 receives the metadata and the structured AI responses transmitted in step 160 and stores the metadata and the structured AI responses for subsequent analytical processing.

The method proceeds from step 160 to step 192. In step 192, the serverless cloud backend 122 correlates the stored metadata with external data received from an external data source 134 to perform cross-domain anomaly detection. The external data source 134 may comprise a point-of-sale system, a revenue tracking system, or another business intelligence data source. The serverless cloud backend 122 identifies relationships between scene-derived observations contained in the stored metadata and business metrics contained in the external data by comparing temporal patterns, threshold crossings, and statistical deviations across both datasets. For example, the serverless cloud backend 122 may correlate shelf emptiness observations derived from the stored metadata with revenue data received from the external data source 134 to detect an inverse relationship between shelf emptiness and sales performance at a particular geographic location.

The method proceeds from step 192 to step 194. In step 194, the serverless cloud backend 122 generates threshold-triggered proactive notifications based on the cross-domain anomaly detection performed in step 192. The threshold-triggered proactive notifications generated in step 194 alert users when a condition identified through cross-domain anomaly detection crosses a predefined threshold. For example, when the correlation performed in step 192 detects that shelf emptiness at a particular store exceeds a predefined threshold and the revenue data from the external data source 134 indicates a corresponding decline in sales, the serverless cloud backend 122 generates a proactive notification in step 194 alerting a store manager to the condition so that the store manager may take corrective action while the condition is still occurring rather than discovering the condition through retrospective analysis.

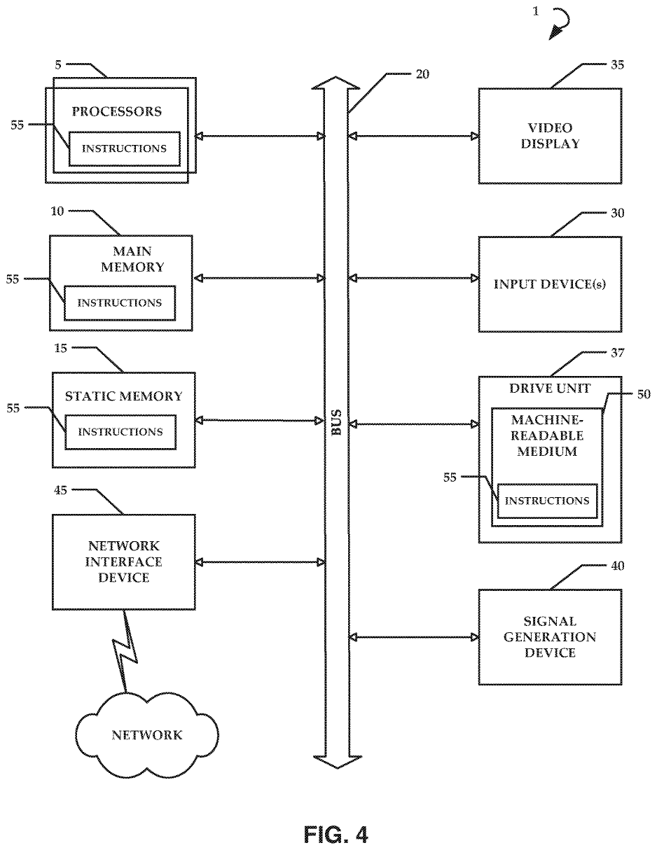

Referring to FIG. 4, a diagrammatic representation of an example machine in the form of a computer system 1, within which a set of instructions for causing the machine to perform any one or more of the methodologies discussed herein may be executed, is shown. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the systems described herein can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

What is claimed is:

1. A system comprising:
a smart camera comprising a processing unit, a memory coupled to the processing unit, and an image sensor configured to capture a live video stream;
an on-camera agentic application stored in the memory and configured to be executed by the processing unit, the on-camera agentic application comprising:
a continuous keyframe extraction module configured to extract keyframes from the live video stream;
an image compression and preprocessing module configured to compress the extracted keyframes to reduce data size; an external AI processing module configured to transmit the compressed keyframes to an external artificial intelligence service via a network and to receive structured AI responses from the external artificial intelligence service, the structured AI responses representing characteristics of scenes captured in the live video stream; and
an infinite metadata generation module configured to continuously generate an unbounded stream of metadata from the structured AI responses, the metadata representing quantitative and qualitative attributes of the captured scenes; and
a serverless cloud backend communicatively coupled to the on-camera agentic application via the network and configured to receive the metadata and the structured AI responses from the on-camera agentic application, store the metadata and the structured AI responses, and perform real-time analytics on the stored metadata.

2. The system of claim 1, wherein the external AI processing module is configured to perform a dual-stage AI processing pipeline on the compressed keyframes, the dual-stage AI processing pipeline comprising a first stage configured to perform a low-cost filtering pass on the compressed keyframes and a second stage configured to perform an advanced analysis via the external artificial intelligence service, the second stage being engaged upon satisfaction of a predefined condition evaluated by the first stage.

3. The system of claim 1, wherein the on-camera agentic application further comprises a standardized event conversion module configured to convert the structured AI responses and the metadata into event messages compliant with at least one standardized communication protocol.

4. The system of claim 1, wherein the smart camera further comprises an application-specific integrated circuit configured to detect predefined triggering events from the live video stream, and wherein the continuous keyframe extraction module is configured to extract the keyframes in response to the predefined triggering events detected by the application-specific integrated circuit.

5. The system of claim 1, wherein the image compression and preprocessing module is further configured to perform a composite-image transformation by arranging a plurality of sequential frames from the live video stream into a single composite image to provide the external artificial intelligence service with contextual temporal awareness.

6. The system of claim 1, wherein the external AI processing module is configured to generate the structured AI responses by analyzing collective behavioral patterns of a plurality of subjects within the captured scenes, the collective behavioral patterns comprising trajectories and reactions of the plurality of subjects relative to one another.

7. The system of claim 1, wherein the serverless cloud backend is further configured to correlate the stored metadata with external data received from an external data source to perform cross-domain anomaly detection and to generate threshold-triggered proactive notifications based on the cross-domain anomaly detection.

8. A method comprising:
capturing, via an image sensor of a smart camera comprising a processing unit and a memory coupled to the processing unit, a live video stream; extracting, via a continuous keyframe extraction module of an on-camera agentic application stored in the memory and executing on the processing unit, keyframes from the live video stream;
compressing, via an image compression and preprocessing module of the on-camera agentic application, the extracted keyframes to reduce data size;
transmitting, via an external AI processing module of the on-camera agentic application, the compressed keyframes to an external artificial intelligence service via a network;
receiving, from the external artificial intelligence service via the network, structured AI responses representing characteristics of scenes captured in the live video stream;
continuously generating, via an infinite metadata generation module of the on-camera agentic application, an unbounded stream of metadata from the structured AI responses, the metadata representing quantitative and qualitative attributes of the captured scenes;
transmitting, via the network, the metadata and the structured AI responses to a serverless cloud backend;
storing, by the serverless cloud backend, the metadata and the structured AI responses; and
performing, by the serverless cloud backend, real-time analytics on the stored metadata.

9. The method of claim 8, wherein transmitting the compressed keyframes to the external artificial intelligence service comprises performing a dual-stage AI processing pipeline, the dual-stage AI processing pipeline comprising: performing a low-cost filtering pass on the compressed keyframes in a first stage; and upon satisfaction of a predefined condition evaluated in the first stage, engaging the external artificial intelligence service to perform an advanced analysis on the compressed keyframes in a second stage.

10. The method of claim 8, wherein compressing the extracted keyframes further comprises performing a composite-image transformation by arranging a plurality of sequential frames from the live video stream into a single composite image to provide the external artificial intelligence service with contextual temporal awareness.

11. The method of claim 8, further comprising converting, via a standardized event conversion module of the on-camera agentic application, the structured AI responses and the metadata into event messages compliant with at least one standardized communication protocol.

12. The method of claim 8, further comprising: receiving, by the on-camera agentic application, a user-defined structured prompt specifying a query for real-time evaluation of the live video stream; and transmitting the user-defined structured prompt together with the compressed keyframes to the external artificial intelligence service for analysis of the compressed keyframes according to the user-defined structured prompt.

13. The method of claim 8, further comprising generating, based on the structured AI responses, a real-time output directed to an individual within a scene captured by the live video stream, the real-time output comprising at least one of a verbal output through a speaker communicatively coupled to the smart camera or a visual output through a digital display communicatively coupled to the smart camera.

14. The method of claim 8, wherein the serverless cloud backend comprises a schema-free database, and wherein performing real-time analytics on the stored metadata comprises incorporating dynamically extensible data attributes into the real-time analytics without requiring modification to a schema of the schema-free database.

15. A system comprising:
a smart camera comprising a processing unit, a memory coupled to the processing unit, and an image sensor configured to capture a live video stream; an on-camera agentic application stored in the memory and configured to be executed by the processing unit, the on-camera agentic application comprising:
a continuous keyframe extraction module configured to extract keyframes from the live video stream;
an image compression and preprocessing module configured to compress the extracted keyframes to reduce data size;
an external AI processing module configured to perform a dual-stage AI processing pipeline on the compressed keyframes, the dual-stage AI processing pipeline comprising a first stage configured to perform a low-cost filtering pass on the compressed keyframes and a second stage configured to transmit the compressed keyframes to an external artificial intelligence service via a network and to receive structured AI responses from the external artificial intelligence service upon satisfaction of a predefined condition evaluated by the first stage, the structured AI responses representing characteristics of scenes captured in the live video stream;
an infinite metadata generation module configured to continuously generate an unbounded stream of metadata from the structured AI responses, the metadata representing quantitative and qualitative attributes of the captured scenes; and
a standardized event conversion module configured to convert the structured AI responses and the metadata into event messages compliant with at least one standardized communication protocol;
a serverless cloud backend communicatively coupled to the on-camera agentic application via the network and configured to receive the metadata and the structured AI responses from the on-camera agentic application, store the metadata and the structured AI responses in a schema-free database, and perform real-time analytics on the stored metadata, the schema-free database configured to accommodate dynamically extensible data attributes without requiring database schema modifications; and a user interface module communicatively coupled to the on-camera agentic application and to the serverless cloud backend and configured to route real-time queries to the on-camera agentic application for immediate AI evaluation of the live video stream and to route analytical queries to the serverless cloud backend for historical data analysis of the stored metadata.

16. The system of claim 15, wherein the on-camera agentic application is configured to operate as a compiled binary within a camera application platform of the smart camera, the on-camera agentic application configured to perform kernel-level event monitoring and direct sensor interactions with the image sensor.

17. The system of claim 15, wherein the smart camera further comprises an application-specific integrated circuit configured to detect predefined triggering events from the live video stream, and wherein the continuous keyframe extraction module is configured to extract the keyframes in response to the predefined triggering events detected by the application-specific integrated circuit, the predefined triggering events comprising detection of at least one of a human, a license plate, or an object of interest.

18. The system of claim 15, wherein the user interface module is communicatively coupled to the on-camera agentic application and to the serverless cloud backend via a secure communication protocol comprising at least one of HTTPS or WebSocket.

19. The system of claim 15, wherein the serverless cloud backend is further configured to aggregate the stored metadata received from a plurality of smart cameras deployed across a plurality of geographic locations and to perform the real-time analytics across the plurality of geographic locations and across a plurality of timeframes.

20. The system of claim 15, further comprising a scene interaction output module communicatively coupled to the on-camera agentic application and configured to generate, based on the structured AI responses, at least one of a verbal output through a speaker or a visual output through a digital display directed to an individual within a scene captured by the live video stream.
